(19) United States
(12) Patent Application Publication
(10) Pub. No.: US 2010/0250903 A1
(43) Pub. Date: Sep. 30, 2010

(54) APPARATUSES AND SYSTEMS INCLUDING A SOFTWARE APPLICATION ADAPTATION LAYER AND METHODS OF OPERATING A DATA PROCESSING APPARATUS WITH A SOFTWARE ADAPTATION LAYER

(75) Inventor: David Aaron Jensen, Cedar Hills, UT (US)

Correspondence Address: MADSON IP, Old Shepard Commons, Suite 230, 1466 North Highway 89, Farmington, UT, 84025, US

(73) Assignee: Celio Technology Corporation

(21) Appl. No.: 12/708,398

(22) Filed: Feb. 18, 2010

Related U.S. Application Data
(60) Provisional application No. 61/163,551, filed on Mar. 26, 2009.

(51) Int. Cl. G06F 9/30

(52) U.S. Cl. 712/220; 712/E09.016

(57) ABSTRACT

A software application adaptation layer is comprised of a program file comprising a plurality of adaptation filters and a configuration file. The configuration file may designate one or more adaptation filters of the plurality of adaptation filters to be applied by the program file for modifying one or more behaviors of an active software application. A data processing apparatus including such a software application adaptation layer includes processing circuitry configured to execute instructions for the active software application, a communications module coupled to the processing circuitry and at least one storage medium for storing the program file and the configuration file. Operational methods for such an apparatus includes storing the program file and the configuration file in the at least one storage medium, identifying the active software application, generating an adaptation filter set and attaching the adaptation filter set to an input queue associated with the active software application.

### CROSS-REFERENCE TO RELATED APPLICATIONS

This application claims the benefit and is a continuation-in-part application of U.S. Provisional Patent Application Ser. No. 61/163,551 that was filed on Mar. 26, 2009, the entire disclosure of which is incorporated herein by this reference.

### TECHNICAL FIELD

The present disclosure relates to electronic data processing systems that operate one or more software applications. In particular, the present disclosure pertains to the adaptation of one or more behaviors of a software application.

### BACKGROUND

Data processing systems that enable a user to operate one or more software applications for performing a task or operation are ubiquitous. So the user may interact with the system, one or more input\output devices are typically employed, including a visual display. In some cases, a software application employed by the data processing system is designed or coded to the characteristics of a specific environment. For example, a software application configured for use on a mobile data processing system configured as a hand-held device (e.g., a cellular telephone, smartphone, personal digital assistant (PDA), personal media player, etc.) may be coded for the characteristics of the specific display incorporated into the hand-held device. When a software application is coded for use on a single display, the software application may display very poorly when it is exhibited on another display, different from the originally intended display. For example, a software developer may make assumptions about the width or height of the display, and may fail to draw the background of the application window beyond the dimensions of the original display.

Historically, this type of problem remained an issue solely for the application vendor. If the vendor wished to support additional environments (e.g., display devices), the vendor was responsible for writing code into the application to resolve those issues. More currently, however, this has become a problem for third parties who wish to create alternative environments (e.g., alternative displays) that are usable for a wide variety of software applications, since the software applications may contain assumptions about their intended environment that causes them to behave incorrectly in a third-party environment having one or more different characteristics.

One specific example of this problem exists on smartphones, where a software application written for one specific phone may be coded with the assumption that the software application will always be displayed on the specific smartphone's physical display. For example, a smartphone dialer application and settings applets are conventionally provided by the phone vendor, who often assumes that these applications will only be displayed on their own phone's hardware. When these software applications are connected to a remote display device, such as a third-party display, the software application may exhibit a range of incorrect behaviors. This problem can exist in other environments as well, including remote desktop protocol (RDP).

One conventional approach to the above described compatibility problem is to provide code in the information processing system that employs a combination of hooks and external methods to generally coerce a badly-behaving software application into behaving properly in a new environment. This code is referred to throughout the present disclosure as an “adaptation layer” which may also be referred to as a “software application adaptation layer.” However, several shortcomings exist with such conventional solutions. For example, the code must contain long lists of supported applications, fixes for one application often break support for other applications, performance problems occur when the adaptation layer checks frequently to determine whether to apply specific fixes to each application window, each combination of hardware, operating system, and application may require different fixes, requiring very complex code, the release of new hardware, new operating system versions, and new applications requires releasing new versions of the adaptation layer very frequently, and only software engineers are able to develop or test fixes to support new hardware or new applications. As a result of such shortcomings, conventional adaptation layers have been associated with limited scope and high cost.

### BRIEF SUMMARY

Various embodiments of the present disclosure comprise a data processing apparatus including a software application adaptation layer comprised of at least two independent files for modifying a behavior of one or more software applications. In one or more embodiments, an apparatus including a software application adaptation layer comprises processing circuitry for executing instructions for an active software application. A communications module and at least one storage medium are coupled to the processing circuitry. The one or more storage media includes a program file comprising a plurality of adaptation filters and a configuration file. The configuration file designates at least one adaptation filter of the plurality of adaptation filters to be applied by the program file for modifying one or more behaviors of the active software application.

Additional embodiments of the present disclosure include systems having a software application adaptation layer for adapting a software application for exhibition on a display device. In one or more embodiments, such systems comprise a display device operably coupled to processing circuitry. At least one storage medium is coupled to the processor and comprises a configuration file and a program file including a plurality of adaptation filters. The program file is configured to cause the processing circuitry to identify an active software application, generate an adaptation filter set and attach the adaptation filter set associated with the active software application. The adaptation filter set comprises one or more adaptation filters of the plurality of adaptation filters, and the one or more adaptation filters of the adaptation filter set is designated by the configuration file.

In yet other embodiments, the present disclosure includes operational methods for a data processing apparatus. One or more embodiments of such methods may comprise storing a program file and a configuration file in at least one storage medium. An active software application is identified and an adaptation filter set is generated. The adaptation filter set comprises at least one adaptation filter from a plurality of adaptation filters of the program file. The at least one adaptation filter of the adaptation filter set is designated by the configuration file based on the identity of the active software application. The adaptation filter set is then attached to an input queue associated with the active software application.

### BRIEF DESCRIPTION OF THE SEVERAL VIEWS OF THE DRAWINGS

FIG. 1 illustrates an exemplary embodiment of a system incorporating teachings of the present invention to adapt a software application for exhibition on a display device.

FIG. 2 is an overview schematic diagram of selected components of the system of FIG. 1.

FIG. 3 is a schematic flow diagram illustrating adaptation operation and components according to at least one embodiment.

FIG. 4 is a flow chart depicting steps in a method embodying teachings of the present disclosure to adapt a software application.

### DETAILED DESCRIPTION

The illustrations presented herein are, in some instances, not actual views of any particular apparatus or system, but are merely idealized representations which are employed to describe the present disclosure. Additionally, elements common between figures may retain the same numerical designation.

In the following detailed description, circuits and functions may be shown in block diagram form in order not to obscure the present disclosure in unnecessary detail. Additionally, block definitions and partitioning of logic between various blocks as depicted is non-limiting, and comprise examples of only specific embodiments. It will be readily apparent to one of ordinary skill in the art that the present disclosure may be practiced in a variety of embodiments implementing numerous other partitioning solutions.

Also, it is noted that the embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process is terminated when its acts are completed. A process may correspond to a method, a function, a procedure, a subroutine, a subprogram, etc. Furthermore, the methods disclosed herein may be implemented in hardware, software, or both.

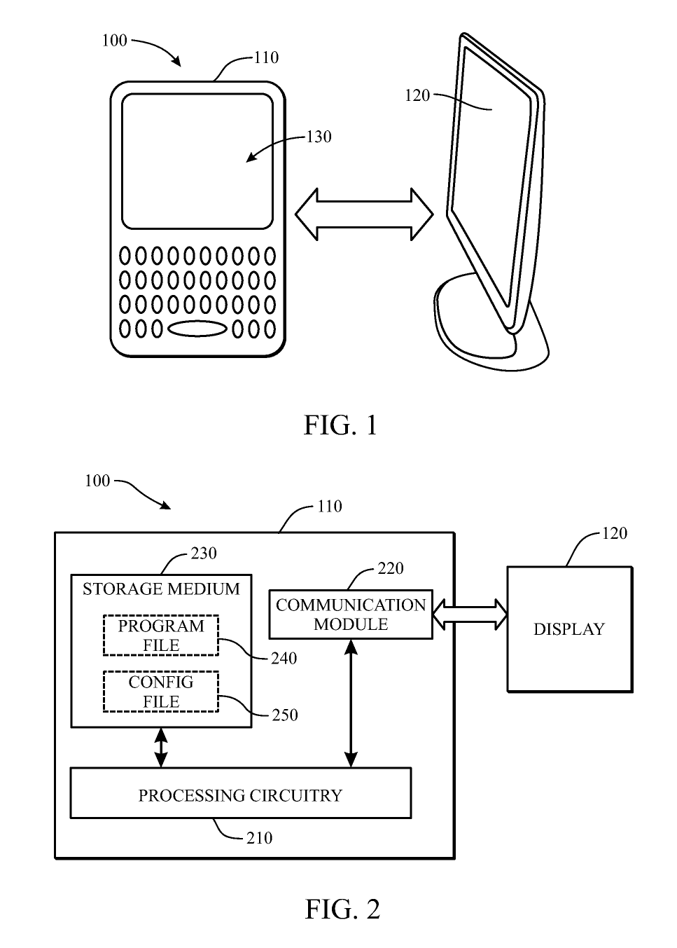

Various embodiments of the present disclosure are directed to embodiments of a data processing apparatus and data processing system for adapting or modifying a behavior of one or more software applications. FIG. 1 illustrates an embodiment of a system 100 in which teachings of the present disclosure can find utility. The system 100 includes a data processing apparatus 110 coupled to a display device 120. The data processing apparatus 110 may include a visual display 130 of its own, or the data processing apparatus 110 may have no visual display therewith. A data processing apparatus 110 may comprise any apparatus configured to process data with one or more processors and one or more storage media, as will be described in further detail herein below. By way of example and not limitation, the data processing apparatus 110 may comprise a cellular telephone, a smart phone, a personal digital assistant, an electronic book, a personal media player (e.g., ZUNE®), a laptop computer, etc.

In some embodiments, the display device 120 may be coupled to the data processing apparatus 110 directly by means of any conventional wired or wireless connection suitable for communicatively coupling a display device with a data processor. In other embodiments, the display device 120 may be coupled to the data processing apparatus 110 indirectly through one or more intermediate devices, such as an enhancer as described in U.S. Ser. No. 12/648,156, the entire disclosure of which is incorporated herein by this reference. By way of example and not limitation, the display device 120 may be coupled to the data processing apparatus 110, directly or indirectly, by means of one or more of an HDMI, USB or FireWire cable, WiFi, BlueTooth, ZigBee, etc.

As used herein, a display device 120 may comprise a physical display (as illustrated) or a virtual display. A virtual display comprises a display that does not require exhibition of images on a physical monitor. In other words, a virtual display does not have to be implemented in hardware, and may be internal to the data processing apparatus 110. By way of example and not limitation, a virtual display according to at least one embodiment of the present disclosure may comprise a display driver installed on the data processing apparatus 110 for performing graphics processing of images even though the images never actually show up on the data processing apparatus itself. Such a display driver comprises a virtual display driver. Another non-limiting example of a virtual display may be implemented in some operating system. Two typical examples include Remote Desktop and Terminal Services for Microsoft Windows operating systems. These implementations provide a virtual display to allow a user to access software applications and data on a terminal server using a remote client machine. The terminal server employs a virtual display to render all the graphics data as though images are to be exhibited on the terminal server, but then communicates those images to the remote client machine, where the images are actually exhibited to the user.

FIG. 2 illustrates a schematic diagram of selected components of system 100 in FIG. 1 according to at least one embodiment. The data processing apparatus 110 comprises processing circuitry 210, a communications module 220 coupled to the processing circuitry 210, and at least one storage medium 230 coupled to the processing circuitry 210. Other arrangements within the scope of the present disclosure are contemplated, including more, fewer and/or alternative components.

The processing circuitry 210 is arranged to obtain, process and/or send data, control data access and storage, issue commands, and control other desired operations. Processing circuitry 210 may comprise circuitry configured to implement desired programming provided by appropriate media in at least one embodiment. For example, the processing circuitry 210 may be implemented as one or more of a processor, a controller, a plurality of processors and/or other structure configured to execute executable instructions including, for example, software and/or firmware instructions, and/or hardware circuitry. Embodiments of the processing circuitry 210 include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the function described herein. A general purpose processor may be a microprocessor but, in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration. These examples of processing circuitry 210 are for illustration and other suitable configurations within the scope of the invention are also contemplated.

The communications module 220 is configured to implement wired and/or wireless communications of the data processing apparatus 110. For example, in at least some embodiments, communications module 220 may be configured to communicate information bi-directionally with respect to the display device 120 as well as other devices of the system 100. The communications module 220 may be coupled with an antenna and may include wireless transceiver circuitry for wireless communications with the display device 120, as well as other devices of the system 100, and may also include as a network interface card (NIC), serial or parallel connection, USB port, FireWire interface, flash memory interface, floppy disk drive, or any other suitable arrangement for communicating with respect to public (e.g., Internet) and/or private networks or other wired arrangements.

The storage medium 230 is configured to store programming such as executable code or instructions (e.g., software and/or firmware), electronic data, databases, or other digital information and may include processor-usable media. As used herein, the storage medium 230 may comprise a single storage medium, or a plurality of storage media, according to various embodiments of the present disclosure. A storage medium 230 may be any available medium that can be accessed by a general purpose or special purpose computer. By way of example and not limitation, a storage medium 230 may comprise one or more devices for storing data, including read-only memory (ROM), random access memory (RAM), magnetic disk storage mediums, optical storage mediums, flash memory devices, and/or other computer-readable mediums for storing information.

Computer-readable media may be embodied in any computer program product(s) or article of manufacture(s) which can contain, store, or maintain programming, data and/or digital information for use by or in connection with an instruction execution system including processing circuitry in the exemplary embodiment. For example, suitable computer-readable media may include any one of physical media such as electronic, magnetic, optical, electromagnetic, infrared or semiconductor media. Some more specific examples of computer-readable media include, but are not limited to, a portable magnetic computer diskette, such as a floppy diskette, zip disk, hard drive, random access memory, read only memory, flash memory, cache memory, and/or other configurations capable of storing programming, data, or other digital information.

At least some embodiments described herein may be implemented using program files and/or configuration files (described in further detail below). Such program files and/or configuration files may be implemented in software, firmware, middleware, or microcode, as well as combinations thereof, wherein the program code or code segments may be stored within appropriate storage media described above and/or communicated via a network or other transmission media and configured to control appropriate processing circuitry. For example, program files and/or configuration files may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet and/or private network), wired electrical connection, optical connection and/or electromagnetic energy, for example, via a communications interface, or provided using other appropriate communication structure or medium. Program files and/or configuration files including processor-readable code may be communicated as a data signal embodied in a carrier wave, in but one example.

With continued reference to FIG. 2, the storage medium 230 comprises at least two individual files, namely a program file 240 comprising at least one adaptation filter capable of modifying at least one behavior of an active software application, and a configuration file 250 configured to designate at least one adaptation filter to be applied by the program file 240 to the active software application. Although the program file 240 and the configuration file 250 are identified as single files throughout this disclosure, it should be understood that either the program file 240, the configuration file 250 or both may also comprise groups of two or more files, such that there may be a group of program files 240 and/or a group of configuration files 250. Furthermore, the program file 240 and the configuration file 250 may be stored on the same storage medium 230 or separate storage media 230, according to various embodiments.

The program file 240 comprises executable code (i.e., compiled binary) and includes one or more independent adaptation filters capable of being applied to an active software application to adapt or modify one or more behaviors of the active software application. For example, in order to adapt an active software application to properly exhibit on one or more display devices, such as display device 120, the program file 240 may apply one or more adaptation filters to modify the active software application to properly exhibit on the one or more display devices. By way of example and not limitation, a list of adaptation filters for modifying one or more behaviors of an active software application in order to adapt the active software application to a display device may include a horizontal center filter, a vertical center filter, a filter to suppress requests to resize the software application, a filter to suppress requests to move the software application, a filter to fill the background to the limit of the software application boundaries, a filter to fill the screen beyond the software application boundaries, a filter to replace a window's font, a filter to reposition child windows, a filter to make one or more registry changes, etc. The foregoing list is not exhaustive but would be sufficient for adapting many software applications for a given display device.

As noted above, the adaptation filters are each independent, meaning they are at least independent of each other and capable of being employed individually or in a set of adaptation filters for any given software application. Independent adaptation filters provide various benefits, including significantly reducing the risk of breaking existing adapters when adding a new one. In at least one embodiment of the program file 240, the adaptation filters are configured as individual decorators, according to the decorator design pattern employed in object-oriented programming. The individual decorators are independent from each other and two or more decorators may be chained together to create a decorator chain that is able to adapt various characteristics of a software application to a given display device. In such implementations, the program file 240 employs a factory object, according to object-oriented computer programming, to generate an appropriate set of decorators—one for each behavior to be modified for a given active software application—by chaining the set of decorators together. Chained together, the decorators comprise a single adapter between the active software application and the display device.

In order to substantially improve flexibility of the adaptation layer of the present disclosure, the program file 240 is configured to obtain a list of required adaptation filters for a given software application from the configuration file 250. The configuration file 250 comprises a data file including adaptation instructions for various software applications. In particular, the configuration file 250 comprises data designating which of the various adaptation filters are to be applied to a particular software application. For example, in at least some embodiments of the present disclosure in which the adaptation filters are configured as decorators, the program file 240 includes all of the decorators, but is configured to look to the configuration file 250 to determine which of all the decorators are required for correctly modifying one or more behaviors of a specific software application. The program file 240 then generates the decorator chain comprising the decorators designated in the configuration file 250 for the specific software application. In some embodiments, the configuration file 250 may be a data file comprising a text file, such as an extensible markup language (XML) text file comprising the configuration instructions.

Because all the necessary independent adaptation filters are included with the program file 240, the program file 240 does not need to be replaced or updated when new hardware platforms, operating systems, or software applications are released. Instead, the configuration file 250 can be replaced or updated, if necessary, to revise the list of designated adaptation filters in view of the new version of the hardware platforms, operating systems, or software applications. In some embodiments of the disclosure, new adaptation filters may be added to the program file 240 as pluggable shared libraries, such as Dynamic Link Libraries (DLL) on a Microsoft Windows operating system. Such plug-ins can be named in the configuration file 250 to allow the new plug-in to be deployed by simply copying the plug-in to a known location.

In embodiments implementing plug-ins, there may be a risk of a third party introducing malicious plug-ins. In some embodiments, to prevent malicious tampering with the plug-ins, the configuration file 250 can be signed by the adaptation layer vendor, and an embedded certificate would be used to validate the signature. Users could still modify the configuration file 250, but only by running the executable with special command line parameters or acknowledging that they know that the configuration file 250 has been modified. In some embodiments, the content of the configuration file 250 may also be shipped in an encrypted format.

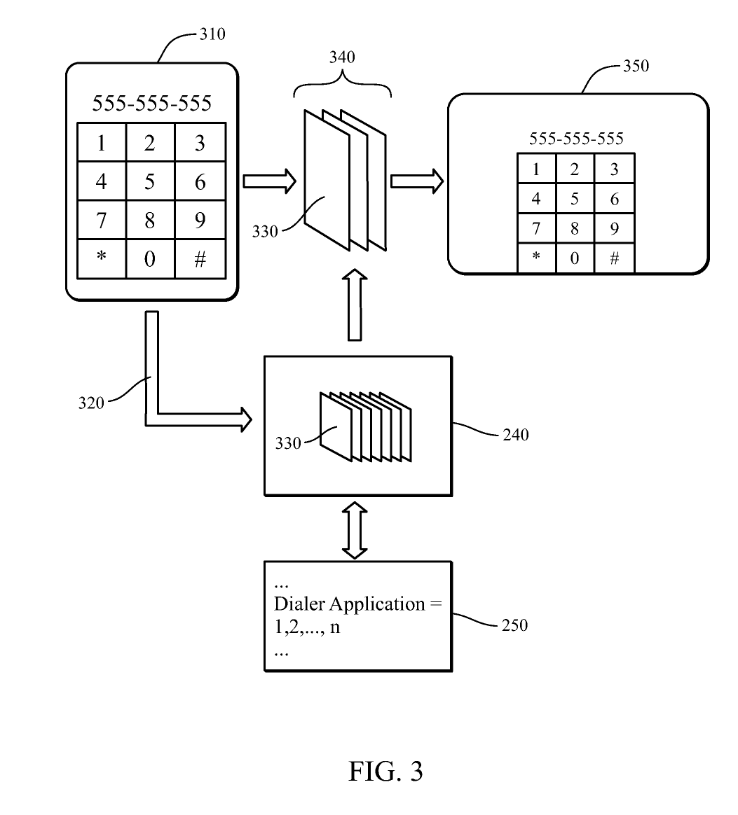

Referring to FIG. 3, adapting a software application to be exhibited by a display device 120 is shown and described according to at least one embodiment of the present disclosure. The following example will be described with reference to a dialer application on a mobile phone as the active software application to be adapted, although other software applications may be employed. It is assumed that the dialer application was originally coded to be exhibited on a visual display incorporated into the data processing apparatus (e.g., visual display 130 of data processing apparatus 110 of FIG. 1). Accordingly, the dialer application is not configured to be exhibited on a display device (e.g., display device 120 of FIGS. 1 and 2) that may be substantially larger (e.g., greater pixel size) and/or differently shaped from the display device for which the dialer application was originally intended. For example, the dialer application may not have coding to instruct the dialer application what to draw in the larger space of a larger screen. More specifically, the dialer application may not know what to draw on lateral sides of the application on a larger screen, it may draw the dialer application off-centered to one side or the other of the larger window or to the top or bottom of the larger window, it may fill extra space with random images from previous applications, etc.

Initially, the dialer application is activated or opened by a user. Upon initiation of the dialer application, a window is opened and a queue associated with that window will receive instructions on how to fill the window with visual aspects of the dialer application. For example, instructions may be communicated to the queue to exhibit the visual aspects of the dialer application in a manner similar to image 310 of FIG. 3, which may be compatible with the characteristics of an originally intended visual display (e.g., visual display 130 of FIG. 1). In other words, image 310 of FIG. 3 is intended to represent the set of instructions communicated to the queue and how that set of instructions would be exhibited on the intended display device.

Upon communication of instructions to the queue, the program file 240 is notified of the active software application, as indicated by arrow 320. The notification may be a result of the program file 240 monitoring the queue for activity by any software application. The program file 240 further identifies the active software application. In the example of FIG. 3, the program file 240 identifies that the active software application is the dialer application. As noted above, the program file 240 may comprise a plurality of independent adaptation filters 330. However, the program file 240 does not include information regarding which of the adaptation filters 330 to apply for the active software application. Instead, such information is stored in and provided by the configuration file 250. Accordingly, the program file 240 is configured to look to the configuration file 250, which identifies the designated adaptation filters 330 for the given software application. In the present example, the configuration file 250 identifies various adaptation filters 330 1, 2, . . . , n, where n is any number of adaptation filters, required to properly exhibit the dialer application on the display device.

Once the program file 240 has received identification of the required adaptation filters 330, the program file 240 generates an adaptation filter set 340 comprising each of the designated adaptation filters 330. In the embodiment described above in which the adaptation filters 330 are configured as decorators, the configuration file 250 identifies the required decorators for the dialer application, and the program file 240 employs a factory object to chain together the designated decorators to generate an adaptation filter set 340 comprising a decorator chain. The adaptation filter set 340 is attached to the dialer application's input queue. By way of example and not limitation, on a Microsoft Windows operating system, the adaptation filter set 340 may be attached to the dialer application's input queue using a SetWindowsHookEx function. It will be apparent to a person of ordinary skill in the art that alternative functions for attaching the adaptation filter set 340 to an active application's input queue may be employed according to the particular programming and/or the particular operating system.

With the adaptation filter set 340 attached to the dialer application's input queue, each set of instructions on the input queue are filtered through the adaptation filter set 340, and the filtered instructions are communicated to the display device, resulting in modified instructions to exhibit the visual aspects of the dialer application in a manner illustrated by modified image 350, which is suitable for exhibition by the larger and/or differently shaped display device.

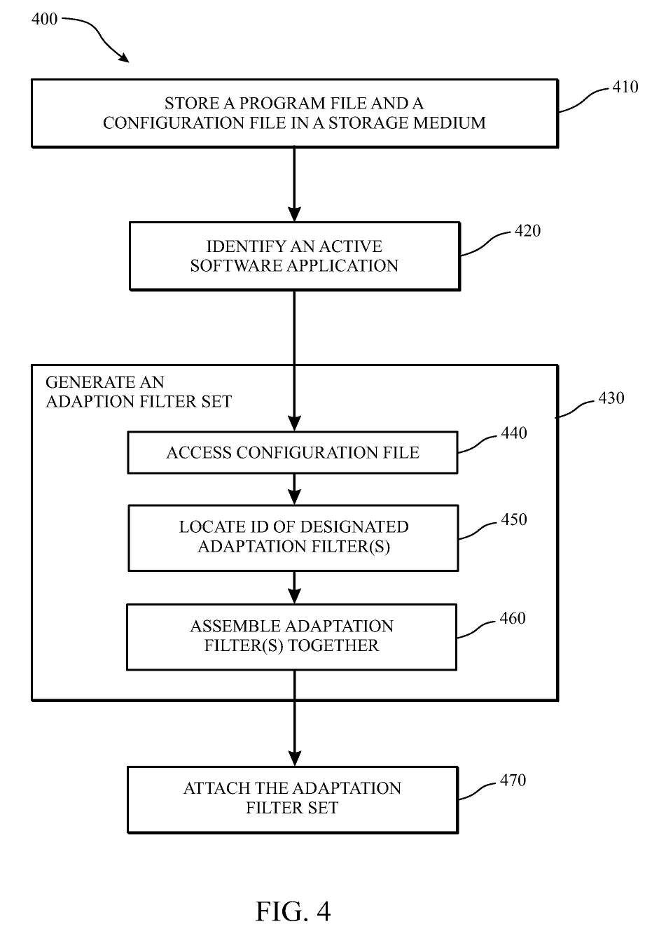

Additional embodiments of the present disclosure are directed to methods of operating a data processing apparatus for adapting one or more behaviors of a software application. FIG. 4 is a flow diagram illustrating a method 400 of adapting a software application according to at least one embodiment of the disclosure. The following method will be described with reference to the flow diagram of FIG. 4 as well as with reference to at least some of the elements described with reference to FIG. 2. Initially, at step 410, a program file 240 and a configuration file 250 are stored on a storage medium, such as storage medium 230. As described above, the program file 240 comprises a plurality of adaptation filters. In at least some embodiments, the adaptation filters may each comprise a pluggable shared library, such as a DLL. The configuration file 250 comprises a data file and, in some embodiments, may comprise an XML file. The configuration file 250 includes a list of one or more software applications and a designation of one or more adaptation filters to be applied to each of the one or more software applications, and may be easily replaced in the storage medium 230 with a revised configuration file.

A software application may be launched or otherwise made active, and the active software application may be identified by the data processing apparatus 110 at step 420. Upon identifying the active software application, the method generates an adaptation filter set at step 430. The adaptation filter set comprises one or more adaptation filters selected from the plurality of adaptation filters of the program file 240. As has been set forth herein above, the one or more adaptation filters comprising the adaptation filter set are designated by the configuration file 250 based on the identity of the active software application.

In at least one embodiment, the adaptation filter set is generated by accessing at step 440 the configuration file 250, and locating at step 450 some data associated with the active software application identifying which adaptation filters of the plurality of adaptation filters are designated for the active software application. By way of example and not limitation, the configuration file 250 may include a text file including a list of software applications. For each software application, the text file may include a list designating one or more adaptation filters to be applied. After the identity of the designated adaptation filters is located, each of the identified adaptation filters may be assembled together at step 460.

In at least some embodiments in which each of the adaptation filters comprises a decorator, the located data from step 450 that is associated with the active software application will identify one or more decorators designated for the active software application. Furthermore, in such embodiments, the decorators may be assembled together at step 460 by chaining the decorators to form a decorator chain.

After the adaptation filter set is generated, the adaptation filter set is attached to an input queue associated with the active software application at step 470. As set forth previously herein, the adaptation filter set may be attached to the input queue using a SetWindowsHookEx function in a Microsoft Windows operating system environment.

Employing various embodiments of the present disclosure to combine adaptation filters and form a single adaptation filter set from instructions obtained by a configuration file enables a business process for revising an application adaptation layer that is significantly different from a conventional business process. In a conventional business process, the vendor of an application adaptation layer learns about a compatibility problem, directs a software engineer to provide a fix, and then releases new software to support their customers. In accordance with embodiments of the present disclosure, the vendor of an application adaptation layer may learn about a compatibility problem, direct a tester or content expert to investigate which filters need to be applied for correcting the problem, and then releases an updated configuration file. No development time is required, and no new software is released. In addition to reporting compatibility problems, field or support personnel can also propose and test changes to the configuration files. Thus, the vendor of an application adaptation layer employing embodiments of the present disclosure is able to provide rapid responses to software application compatibility requirements while leaving the tested code of the program file unchanged. Accordingly, the vendor may achieve a significant business advantage by reducing the cost of supporting new applications, operating systems, and hardware platforms, allowing field personnel and customers to propose and test configuration changes, and eliminating the need to ship modified software.

Although portions of this disclosure describe embodiments for adapting a software application for exhibition on a display device 120, embodiments of the present disclosure can apply broadly to implementations where there is no display device 120 employed. For example, the program file 240 may be employed for managing one or more software applications and adapting or modifying a particular software application's behavior. In such embodiments, an adaptation filter set as described herein can be applied to the processes of the particular software application by the program file 240. Additionally, some portions of the present disclosures describe embodiments and examples suitable for a Microsoft Windows or Windows Mobile operating system. However, a person of ordinary skill in the art will recognize that the present disclosure has utility on various operating systems and will understand how to apply the teachings herein to such alternative operating systems. By way of example and not limitation, teachings of the present disclosure may find utility on operating systems including Microsoft Windows and Windows Mobile, Android, Linux, Unix, RIM BlackBerry OS, etc. Finally, embodiments of the present disclosure may also include a configuration file that is substantially empty.

Accordingly, the described embodiments are to be considered in all respects only as illustrative, and not restrictive. The present invention may be embodied in other specific forms without departing from its structures, methods, or other essential characteristics as broadly described herein and claimed hereinafter. The scope of the invention is, therefore, indicated by the appended claims, rather than by the foregoing description. All changes that come within the meaning and range of equivalency of the claims are to be embraced within their scope.

What is claimed is:

1. A data processing apparatus including a software application adaptation layer for modifying a behavior of a software application, comprising:
processing circuitry configured to execute instructions for an active software application;
a communications module coupled to the processing circuitry; and
at least one storage medium coupled to the processing circuitry, the at least one storage medium comprising:
a program file comprising a plurality of adaptation filters; and
a configuration file designating at least one adaptation filter of the plurality of adaptation filters to be applied by the program file for modifying one or more behaviors of the active software application.

2. The data processing apparatus of claim 1, wherein the program file is configured to cause the processing circuitry to:
identify the active software application;
obtain from the configuration file an identification of the designated at least one adaptation filter to be applied for modifying the one or more behaviors of the active software application;
generate an adaptation filter set comprising the at least one adaptation filter identified by the configuration file; and
attach the adaptation filter set to an input queue associated with the active software application.

3. The data processing apparatus of claim 1, wherein each adaptation filter of the plurality of adaptation filters comprises a pluggable shared library.

4. The data processing apparatus of claim 1, wherein each adaptation filter of the plurality of adaptation filters comprises a decorator.

5. The data processing apparatus of claim 1, wherein the configuration file comprises an extensible markup language (XML) text file.

6. A system including a software application adaptation layer for adapting a software application for exhibition on a display device, comprising:
a display device;
processing circuitry operably coupled to the display device; and
at least one storage medium coupled to the processor, comprising:
a configuration file; and
a program file comprising a plurality of adaptation filters, the program file configured to cause the processing circuitry to:
identify an active software application;
generate an adaptation filter set comprising one or more adaptation filters of the plurality of adaptation filters, wherein the one or more adaptation filters of the adaptation filter set is designated by the configuration file; and
attach the adaptation filter set to an input queue associated with the active software application.

7. The system of claim 6, wherein the display device comprises at least one of a physical display or a virtual display.

8. The system of claim 7, wherein the display device comprises a physical display, and wherein the processing circuitry is operably coupled to the physical display through a communications module.

9. The system of claim 6, wherein the configuration file comprises a group of configuration files.

10. The system of claim 6, wherein the program file comprises a group of program files.

11. The system of claim 6, wherein the configuration file comprises an extensible markup language (XML) file.

12. The system of claim 6, wherein each adaptation filter of the plurality of adaptation filters comprises a decorator.

13. The system of claim 12, wherein the program file is configured to generate an adaptation filter set comprising a decorator chain.

14. The system of claim 6, wherein the plurality of adaptation filters comprise adaptation filters selected from the list of adaptation filters consisting of a horizontal center filter, a vertical center filter, a filter to suppress requests to resize the software application, a filter to suppress requests to move the software application, a filter to fill the background to the limit of the software application boundaries, a filter to fill the screen beyond the software application boundaries, a filter to replace a window's font, a filter to reposition child windows and a filter to make one or more registry changes.

15. A method operational for a data processing apparatus, comprising:
storing a program file and a configuration file in at least one storage medium;
identifying an active software application;
generating an adaptation filter set comprising at least one adaptation filter from a plurality of adaptation filters of the program file, wherein the at least one adaptation filter of the adaptation filter set is designated by the configuration file based on the identity of the active software application; and
attaching the adaptation filter set to an input queue associated with the active software application.

16. The method of claim 15, wherein storing the program file in the at least one storage medium comprises storing a program file comprising a plurality of adaptation filters, each adaptation filter comprising a pluggable shared library.

17. The method of claim 15, wherein generating the adaptation filter set comprises:
accessing the configuration file;
locating in the configuration file an identification of the at least one adaptation filter designated for the identified active software application; and
assembling each of the at least one adaptation filter together.

18. The method of claim 17, wherein:
locating in the configuration file the identification of the at least one adaptation filter designated for the identified active software application comprises locating in the configuration file the identification of at least one decorator designated for the identified active software application; and
assembling each of the at least one adaptation filter together comprises chaining the at least one decorator to form a decorator chain.

19. The method of claim 15, wherein attaching the adaptation filter set to an input queue associated with the active software application comprises attaching the adaptation filter set to the input queue using a SetWindowsHookEx function.

20. The method of claim 15, further comprising replacing the configuration file in the at least one storage medium with a revised configuration file.
